(19) United States
(12) Patent Application Publication
(10) Pub. No.: US 2008/0020665 A1
(43) Pub. Date: Jan. 24, 2008

(54) Collapsible garment and equipment bag having both an impermeable and permeable surface and method for immediate containment of soiled materials therein

(76) Inventor: Nicholas P. Martin, Shirley, NY (US)

Correspondence Address: Mitchell A. Stein, Esq.;STEIN LAW, P.C., Suite 4, 24 Woodbine Avenue, Northport, NY, 11768, US

(21) Appl. No.: 11/408,765

(22) Filed: Jul. 19, 2006

(51) Int. Cl. B32B 15/14

(52) U.S. Cl. 442/235

(57) ABSTRACT

A collapsible garment and equipment bag having an impermeable surface to allow the user to disrobe and/or place soiled or wet items directly on the impermeable surface of the bag and then close the bag, so as to prevent contamination of the surface below, yet also containing a permeable surface so as to allow for ventilation. A method for loading the bag also has making the bag so that it has an impermeable surface and a permeable containment portion together into a relatively planar configuration; placing the bag upon a bag placement surface; standing on said impermeable surface of said bag; disrobing and placing at least some of the soiled equipment on the impermeable surface of the bag leaving remaining equipment unplaced in the bag; stepping off the impermeable surface of the bag and onto the bag placement surface; placing at least some of the remaining equipment in the permeable portion of the bag and closing the bag for containment. The sporting event is preferably paint ball. The soiled equipment are shoes, cleats, helmet, mask, gloves, pads and the like. The remaining equipment is jerseys, socks, undergarments, tee shirts, apparel, and the like.

### FIELD OF THE INVENTION

The present invention relates to bags used to transport and store a variety of goods, which facilitate disrobing and/or the packing of often soiled goods, while also allowing breathability to facilitate the evaporation of moisture of the goods contained therein and containment of any soiling and the method of use associated therewith.

### BACKGROUND OF THE INVENTION

The instant invention relates to bags used to transport and store a variety of goods, which allows the user to disrobe or place soiled and/or wet items directly on the impermeable surface of the bag and then close the bag without disturbing the items on the impermeable surface, so as to prevent contamination of other surfaces (or having to stand on a contaminated surface), while also containing a permeable surface, so as to allow for ventilation of the items contained therein. The instant invention also relates to the method of use of the device.

Various industries, sports, hobbies, HAZMAT, etc. require specific garments and equipment that must be contained for travel in a safe, convenient, and efficient manner both before use and especially thereafter when such garments and equipment are soiled from use during the game or other event.

It is generally known that bags, cases, and other carrying containers are used to carry and transport a plurality of different types of goods. Such containment devices are manufactured in a wide variety of shapes and sizes to permit containment of a wide variety of goods, yet such containers ordinarily provide only a fixed space which the user may use to fill with the desired good(s) through a single defined opening, and do not permit robing before an event or disrobing after the event in a manner that separates soiled materials from those that are of less or no soiling.

Bags, such as “duffel bags,” which incorporate a fixed space often make the packing of goods and organization of their contents difficult, due, inter alia, to the restricted aperture, therefore also making it difficult to later retrieve a desired item from the bag.

Furthermore, none of these containment devices provide for more than fixed spaces and fail to facilitate organization for the separation of soiled and/or wet items immediately after use from other more delicate or clean items, thus creating the need for another solution, generally, the use of more than one bag to properly separate such items. These problems are overcome by the instant invention.

Moreover, bags which incorporate a fixed space do not allow for a surface on which the user may disrobe and/or place soiled or wet items, thus requiring the user to find an additional surface to disrobe and/or place soiled or wet items and creating the potential for contamination of other surfaces (or the need to stand on a contaminated surface), as well as continued handling to place the soiled items in more than one bag.

People such as athletes, when finished with a given activity, often wish to change into “street clothes” before traveling to a different location, often for reasons of comfort and practicability, such as to facilitate driving, but also to eliminate the odor and dirt associated with the activity which has soiled the clothing and/or equipment used for that activity. However, removing and storing garments and equipment used in a particular activity without contaminating adjacent areas or without having to pack the bag on a contaminated surface is generally difficult and no longer required as shown hereinbelow.

A further disadvantage of typical bags, cases and other carrying containers is that they lack a means to allow the goods contained therein to breathe, so as to allow moisture to evaporate and odor to ventilate. Lack of proper ventilation may lead to the formation of mildew and other unwanted infestation (including microbial, for example) and cause unwanted odor which may result in the need to replace the items contained therein should the user not remove the items promptly.

Known in the art are bags, cases and other carrying containers which open to provide a planar surface to facilitate packing and unpacking of goods. These devices however fail to provide an impermeable surface for the user to disrobe or place soiled and/or wet items subsequent to use and to thereafter close the bag without altering the contents on the impermeable surface. For example, U.S. Pat. No. 6,193,034 to Fournier shows a collapsible sports bag having a base to which side walls and end walls are hingedly connected, so that the bag may occupy a planar configuration to facilitate loading and unloading of the various compartments contained therein. U.S. Pat. No. 6,250,470 to Mackenzie shows a hinged fishing equipment bag having two hinged side walls which open to occupy a planar configuration also to facilitate loading and unloading of the various compartments contained therein. U.S. Pat. No. 6,966,439 to Weleczki shows a collapsible multipurpose universal carrying bag having two hinged side walls which open to occupy a planar configuration to facilitate loading and unloading of the various compartments contained therein.

Also known in the art are bags, cases and other carrying containers which open to provide an extended planar surface to allow for various activities. These devices however fail to provide an impermeable surface for the user to disrobe or place soiled and/or wet items subsequent to their use, and then thereafter close the bag without altering the items on the impermeable surface. Thus the prior art is differentiable from the instant invention in that in the prior art the items placed on the planar surface must be removed, and the surface retracted, prior to closing the bag, and in that the contents tend to mix between soiled, partially soiled and unsoiled. For example, U.S. Pat. No. 4,468,810 to Longo shows a convertible carrying bag which unfolds and extends into a planar configuration containing a mat assembly. U.S. Pat. No. 5,390,381 to LaMantia shows a beach towel/beach bag combination having two connecting side walls which unzip and extend into a planar configuration containing a beach towel. U.S. Pat. No. 5,454,643 to Sullivan also shows a combination beach towel and tote bag which unfolds and extends into a planar configuration containing a beach towel. U.S. Pat. No. 5,688,052 to Compton shows a combination beach towel and tote bag which unfolds and extends into a planar configuration containing a beach towel having various compartments. U.S. Pat. No. 5,730,529 to Fritz shows a combination beach mat and carrying device which unrolls into a planar configuration having various compartments. U.S. Pat. No. 4,101,994 to Hoyt shows a combination beach bag and blanket which unfolds into a planar configuration containing a beach blanket.

Also known in the art are bags, cases and other carrying containers which have self-contained elements which provide a planar surface for packing and unpacking. These devices, however, fail to provide an impermeable surface for the user to disrobe or place soiled and/or wet items upon and then subsequently close the bag without altering the items on the impermeable surface (thereby avoiding mixing, for example, dirty, muddy or wet equipment or garments with a uniform when playing a game). For example, U.S. Pat. No. 6,742,635 to Hirshberg shows a sports bag including an attached multipurpose mat, yet fails to show the combined elements and advantages of the instant invention. Likewise, U.S. Pat. No. to Davis shows a utility bag including an attached beach mat.

Also known in the art are bags, cases and other carrying containers which allow ventilation of the goods contained therein. These devices however fail to provide an impermeable surface for the user to disrobe or place soiled and/or wet items and then subsequently close the bag without altering the items on the impermeable surface. U.S. Pat. No. 6,652,145 to Valdez shows a ventilated sport bag with a detachable waterproof cover. U.S. Pat. No. 6,467,665 to Jenkins shows a sports equipment bag formed from a mesh material.

It is thus an object of the instant invention to provide a bag to transport and store a variety of goods, which provides the user with a surface to disrobe and/or place soiled or wet items thereupon and then close the bag without altering the contents on said surface, so as to prevent contamination of other surfaces, equipment and clothing (or the need to stand on a contaminated surface), while at the same time allowing for adequate ventilation for the items therein.

It is a further object of the instant invention to provide a device that derives from the method and provides for robing and thereafter disrobing of soiled equipment and/or clothing such that the soiled equipment and/or clothing is isolated in an impermeable location and the remaining clothing and equipment is placed in a separate permeable location, all in a single contained space.

### SUMMARY OF THE INVENTION

The various features of novelty which characterize the present invention are expressly and unambiguously delineated in the claims annexed to and forming part of the disclosure. For a better understanding of the present invention, its practical advantages, and specific objects attained by its use, reference should be had to the drawings and descriptive matter in which there are illustrated and described preferred embodiments of the invention.

According to the present invention, there is provided a collapsible equipment and garment bag having a substantially square or rectangular center portion composed of an impermeable material; at least two substantially square or rectangular perforated end portions attached directly adjacent to each edge of center portion; at least one zipper or other closure which traces the outline of both the perforated end portions and the impermeable center portion; and at least one strap attached at a distal corner of the transverse edge of the impermeable center portion along the axis of fold and again at the distal edge of the proximate perforated end portion.

The garment and equipment bag of the instant invention collapses to form a planar configuration with an impermeable surface to allow the user to disrobe and/or place soiled or wet items. The planar surface maximizes the usable area. Once items are placed on the impermeable surface, the user may then close the bag without altering the items placed on the impermeable surface and contaminating them with other equipment. The garment and equipment bag of the instant invention further contains an impermeable layer to allow the items contained therein proper ventilation.

An advantage of the instant invention is that soiled and/or wet items are allowed to ventilate through a permeable surface, while in the bag, so as to prevent microbial infestation or unwanted odor.

As a result, the instant invention will obviate the need for a separate surface to disrobe and place soiled and/or wet items in order to avoid either contaminating the surface of the bag or standing on a contaminated surface.

The collapsible garment and equipment bag of the present invention can be manufactured in a variety of different sizes and shapes and out of a variety of different materials, depending on the desired characteristics, such as weight, rigidity, etc.

The instant invention also includes a method for loading the bag also has making the bag so that it has an impermeable surface and a permeable containment portion together into a relatively planar configuration; placing the bag upon a bag placement surface; standing on said impermeable surface of said bag; disrobing and placing at least some of the soiled equipment on the impermeable surface of the bag leaving remaining equipment unplaced in the bag; stepping off the impermeable surface of the bag and onto the bag placement surface; placing at least some of the remaining equipment in the permeable portion of the bag and closing the bag for containment. The sporting event is preferably paint ball. The soiled equipment are shoes, cleats, helmet, mask, gloves, pads and the like. The remaining equipment is jerseys, socks, undergarments, tee shirts, apparel, and the like.

Other features will become apparent from reading the disclosure and claims of the instant invention.

### BRIEF DESCRIPTION OF THE DRAWINGS

In the drawings, wherein similar reference characters denote similar elements throughout the several views:

FIG. 1 is a perspective view of a collapsible equipment and garment showing a manner of carrying the invention in accordance with a preferred embodiment of the instant invention;

FIG. 2 is an extended open, top down view of a collapsible equipment and garment bag shown in the expanded planar configuration in accordance with a preferred embodiment of the instant invention;

FIG. 3 is a perspective view of a collapsible equipment and garment bag shown in the expanded planar configuration revealing a manner of indoor use such as in a locker room environment in accordance with a preferred embodiment of the instant invention;

FIG. 4 is a close-up perspective view of a portion of the collapsible equipment and garment bag shown in FIG. 4 in expanded planar configuration revealing the placement of a soiled piece of equipment on the impermeable portion, in accordance with a preferred embodiment of the instant invention;

FIG. 5 is an perspective view in an outdoor environment demonstrating the use of a a preferred embodiment of the instant invention;

FIG. 6 is a perspective view of an alternative embodiment of the subject invention showing pockets for storage of soiled items in an impermeable section;

FIG. 7 is a perspective view of another embodiment of the instant invention including a mechanism for securing the instant device and protection of the interior of a vehicular environment from soiling, in accordance with an alternative embodiment of the instant invention; and

FIG. 8 is a perspective view of a collapsible equipment and garment bag shown in the expanded planar configuration in accordance with another alternative embodiment of the instant invention having separate compartments for separation of soiled and/or wet garments other equipment from those that are not.

### DETAILED DESCRIPTION OF THE PREFERRED EMBODIMENTS

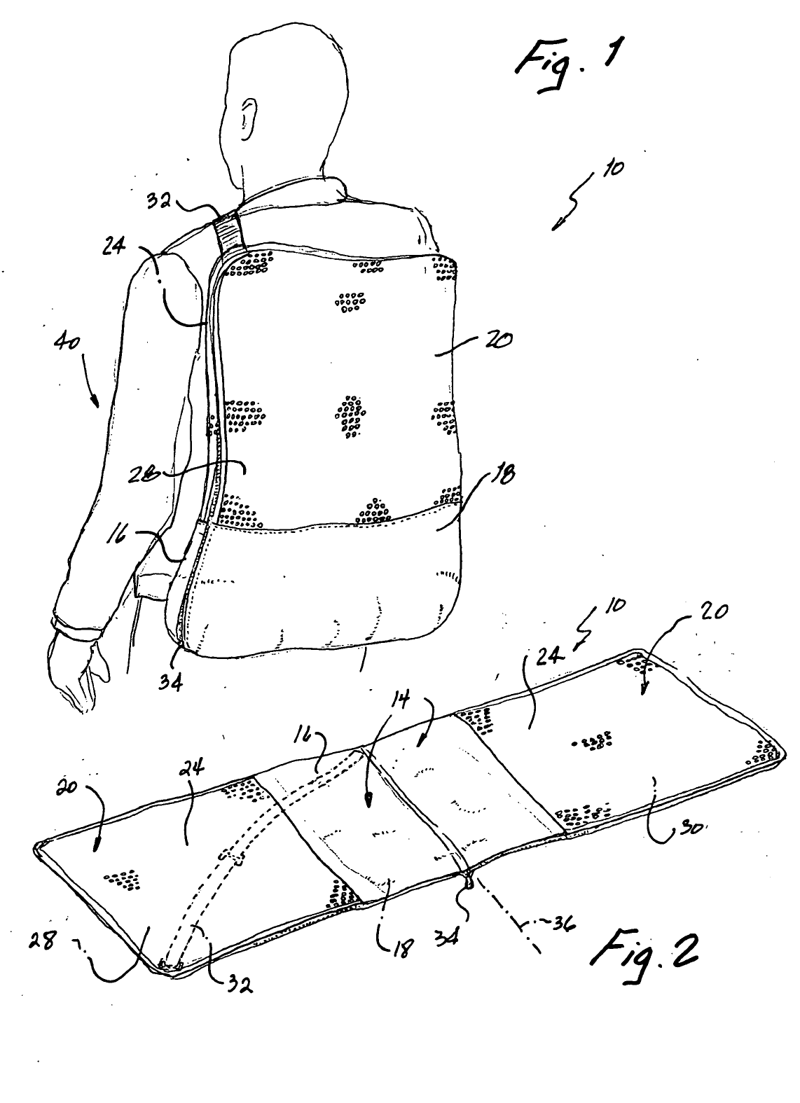

As shown in FIG. 1 and FIG. 2, the present invention is directed to collapsible equipment and garment bag 10 with impermeable center portion 14. Impermeable center portion 14 is comprised of inner surface 16 and outer surface 18; inner surface 16 and outer surface 18 being of roughly the same size, shape, and material so as to allow limited overlap and to permit aligned folding upon insertion of equipment. For the purposes of this description, it should be should be understood by one of ordinary skill in the art that “equipment” includes garments, padding, foot gear, sports equipment and the like.

Impermeable center portion 14 is preferably square or rectangular in shape and is bisected along axis 36 for easy folding for storage and carrying. Impermeable center portion 14 can be made from materials known in the art such as, but not limited to nylon, rubber, polymeric material and natural materials that are both water and stain resistant.

Adjacent to impermeable portions 14 and perpendicular to axis 36 is an end portions 20 comprised of a permeable material also of the same materials as indicated above but with apertures to permit air flow therein. Perforated end portions 20 are comprised of inner surface 24 and outer surface 28. Inner surface 24 and outer surface 28 are shown roughly of the same size, shape, and material so as to allow limited overlap when folding after use along axis 36. It is preferable that perforated end portions 20 are made from a material that allows airflow so that when collapsible garment bag 10 is in a closed position, as shown in FIG. 1, adequate ventilation will be provided for the contents therein. It is also preferable, but not necessary, that perforated end portions 20 are comprised of a material that allows some degree of flexibility, to facilitate loading and unloading without the need to disturb items in doing so.

Zipper 34 tracks the outline of both perforated end portions 20 and impermeable center portion 14. Zipper 34 begins on a distal edge of center portion 14 perpendicular to axis 36 and ends on the opposite distal edges of center portion 14 perpendicular to axis 36. When collapsible garment and equipment bag 10 is zipped, in a closed configuration, said bag is doubled over so as to secure the contents placed on impermeable center portion 14, as shown in FIG. 1. When collapsible garment and equipment bag 10 is unzipped, in the open configuration, said bag forms a planar configuration as shown in FIG. 2. Devices known in the art, such as zippers, are preferable in the instant invention as they will provide for facile opening and closing, when loading and unloading contents. Other closure mechanisms, such as velcro, may however be used without deviating the letter and spirit of the claimed instant invention.

When in the planar configuration, collapsible garment and equipment bag 10 has exposed both inner surface 16 of impermeable center portion 14 and inner surface 24 of permeable, perforated end portions 20. When in the planar configuration, the device is designed so that the user places his feet or bottom with his equipment if soiled upon him and if unsoiled in bag 10 upon the impermeable center portion 14 while robing or disrobing, or alternatively, if disrobing after use places soiled and/or wet items directly on impermeable center portion 14 so as to avoid contaminating any other surface or being contaminated by any other surface.

Strap 32, as shown in FIG. 1, is connected to collapsible equipment and garment bag 10 at a distal corner of outer surface 28 and the transverse edge of impermeable center portion 14 along axis 36 in a manner to facilitate an average person 40 to carry collapsible equipment and garment bag 10, as shown in FIG. 1. Strap 32 can be made from materials known in the art such as, but not limited to, any strap of natural or synthetic material. The location and material of strap 32 are of such that one of ordinary skill in the art, armed with the instant invention, can determine size, shape and location as necessary for the user.

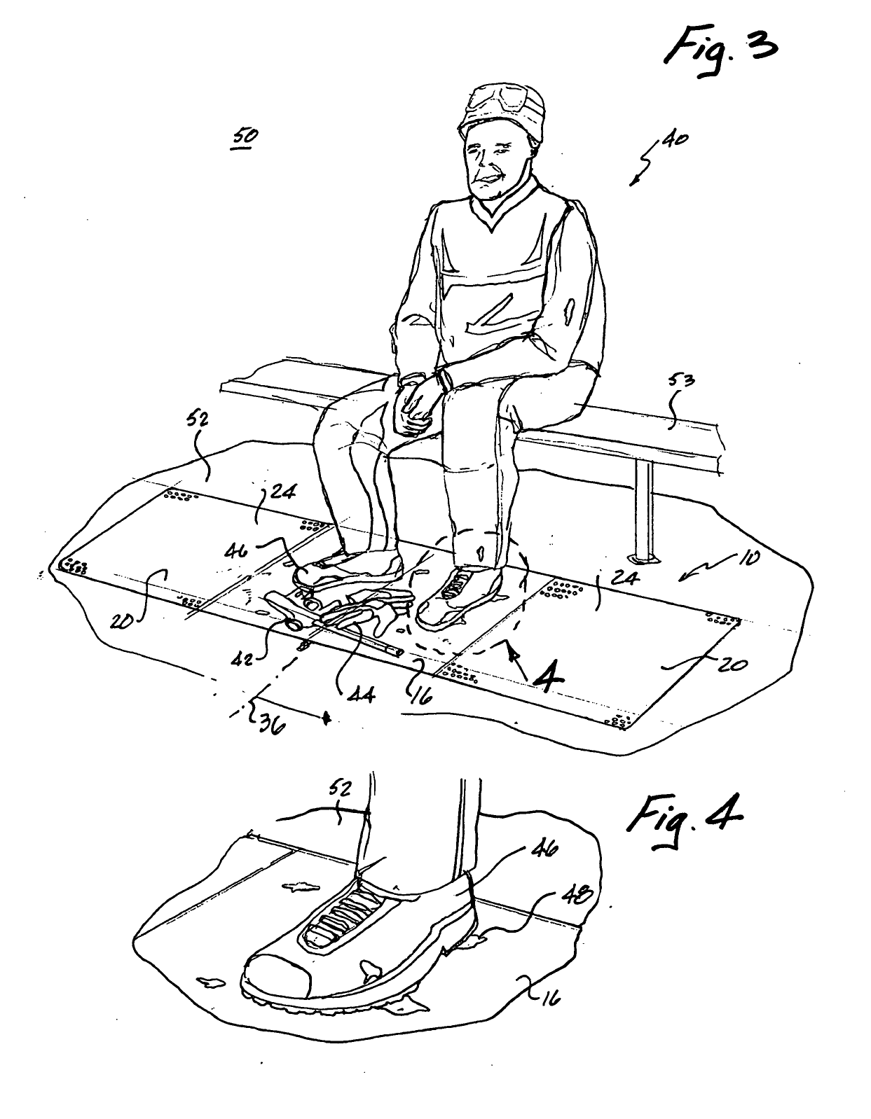

In FIG. 3, collapsible equipment and garment bag 10 is shown in the expanded planar configuration on flooring 52. To utilize the instant invention, average person 40 sits on bench 53 (or the like) and then places his or her feet on impermeable center portion 14. In this instance, the person has already soiled his equipment. Rather than having to use his hands and other surfaces to disrobe and place soiled equipment the instant invention provides the ability to simply sit and disrobe upon impermeable surface 14 placed upon flooring 52. Average person 40 may then take off shoes 46, paint ball gun 42, gloves 44, helmets, goggles, uniforms, or other apparel (“equipment”) and place such other items, as well as other items used and soiled, directly on impermeable center portion 14 so as to avoid contaminating the surface below or further contaminating the items by contacting the surface below, or other surfaces, as well. Impermeable center portion 14 provides a desirable surface to change and/or place items when space is limited or a desirable surface is not available. When in the expanded planar configuration, collapsible equipment and garment bag 10 can easily be loaded with items and then closed without disturbing the location of said items. Such disturbances include the mixing together of soiled and partially or completely unsoiled equipment.

As shown in FIG. 4, in the instances when the instant invention 10 is applied for paint ball tournaments, typically shoes 46 have paint 48 applied thereto. Accordingly, in such instances, paint 48 is placed upon impermeable center portion 14 thereby protecting the paint from contaminating other equipment and surfaces. Collapsible equipment and garment bag 10 maintains paint 48 on impermeable center portion 14 rather than contaminating flooring 52 and other equipment and/or surfaces.

In FIG. 5 collapsible equipment and garment bag 10 is shown in the expanded planar configuration laid on parking lot 72. To utilize the instant invention, outdoorsman/sports official 60 stands on impermeable center portion 14 to avoid having to disrobe and load equipment in puddles of water 74, thus allowing user 60 to prevent his or her shoes 64 from getting wet or their contaminants from spreading. Impermeable center portion 14 provides a location to change and/or place such items. User 60 may then take off his or her shoes 60, uniform 62, or other wet apparel and place them directly on impermeable center portion, close collapsible garment 10 along axis 36 (see FIG. 3) and store collapsible garment and equipment bag 10 containing the wet items (and clean(er) one's in a trunk or car location without getting those areas of the car wet or soiled, thereby isolating the contaminants from contact with other surfaces.

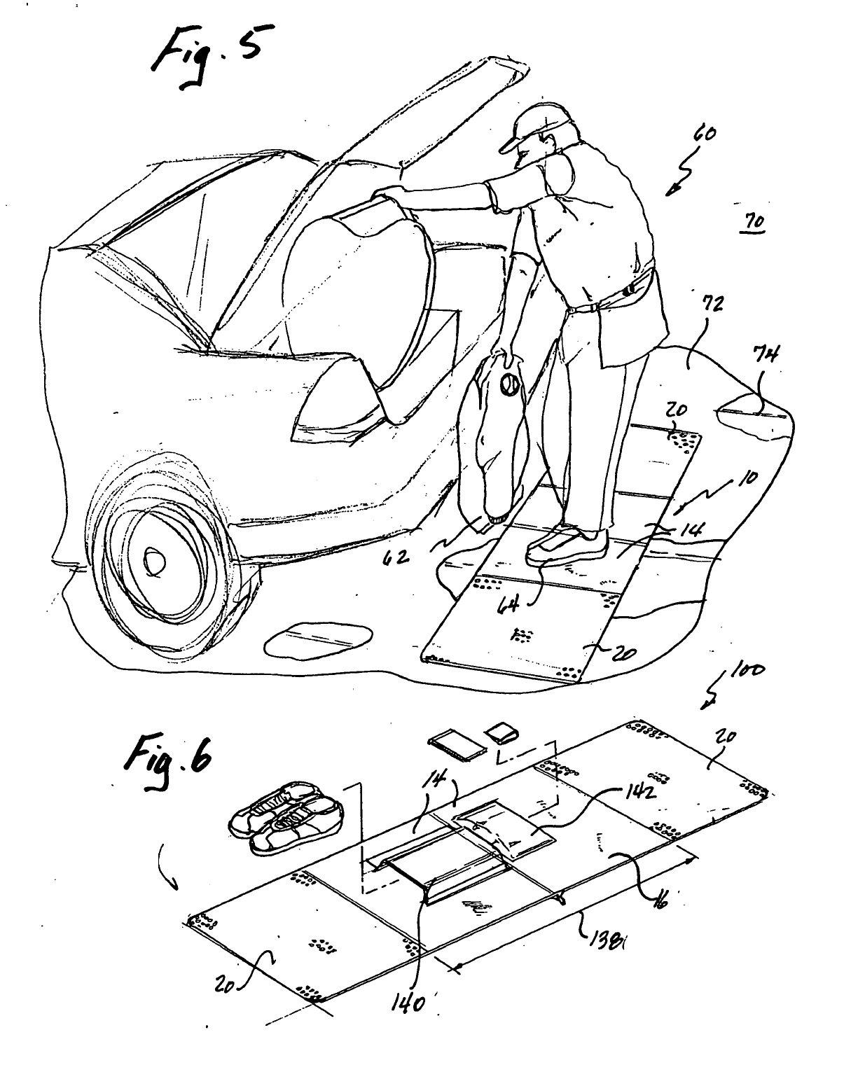

Shown in FIG. 6 is and alternative embodiment 100 of collapsible equipment and garment bag 10 in the expanded planar configuration. Items that are identical bear the same identification number for the same purposes and will not be repeated but rather are incorporated by reference for one of ordinary skill in the art. Embodiment 100 shows a wider dimension, as shown by 138. Impermeable center portion 14 in this alternative embodiment 100 also contains pockets 140 and 142, to secure certain items, if desired, as shown.

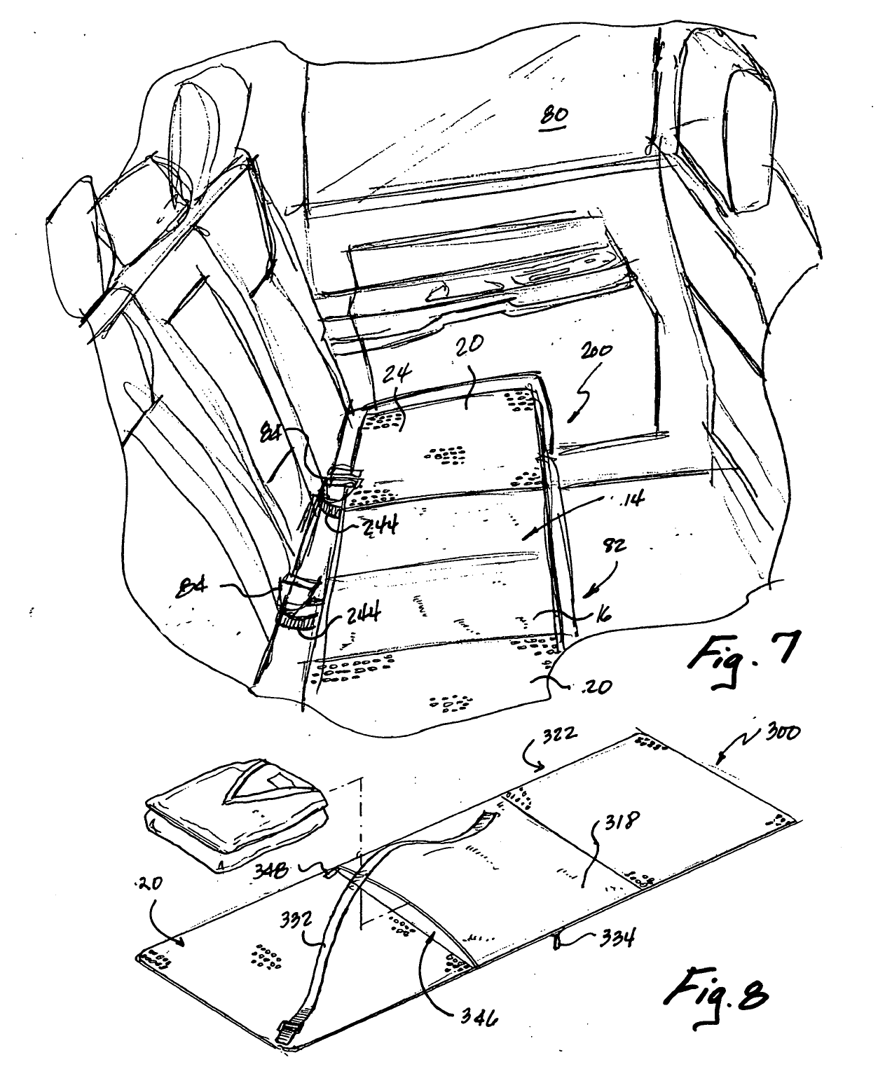

Shown in FIG. 7 is another alternative embodiment 200 of collapsible equipment and garment bag 10 in an expanded planar configuration laid upon the rear seat 82 of a standard automobile 80. Embodiment 200 contains a plurality of securement loops 244 which hook around belt buckles 84 to secure the instant invention to rear seat 82 and are removable once soiled equipment is placed thereupon. Otherwise, the device functions according to the same method set forth hereinabove.

Shown in FIG. 8 is another embodiment 300 of collapsible equipment and garment bag 10 in an expanded planar configuration. In this embodiment, center section 319 forms a pocket 346 closable by zipper or other means 348. Zipper or other means 334 is also shown for closure of the entire device.

While there have shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the invention, therefore, to be limited only as indicated by the scope of the claims appended hereto.

I claim:

1. A collapsible garment and equipment bag for a user comprising:
(a) a rectilinear center portion composed of an impermeable material for placement of a user thereupon;
(b) at least two substantially rectilinear perforated end portions hingedly attached directly adjacent to each distal edge of said center portion;
(c) at least one closure means to resealably connect distal edges of the impermeable center portion and the attached perforated end portions by traversing the edges of both the impermeable center portion and the attached perforated end portions; and
(d) at least one carrying means attached at a distal corner of the transverse edge of said impermeable center portion along the axis of fold and again at the distal edge of the proximate perforated end portion, each on the exterior surface thereof.

2. A collapsible garment and equipment bag according to claim 1, wherein: (a) said center portion comprises inner and outer surfaces, said inner and outer surfaces being of roughly the same size, shape, and material so as to allow limited overlap; and (b) said center portion further comprises an axis of fold, bisecting said center portion, parallel to the edge in which said perforated end portions attach.

3. A collapsible garment and equipment bag according to claim 1, wherein said perforated end portions are comprised of inner surface and outer surface, said inner and outer surfaces being of roughly the same size, shape, and material so as to allow limited overlap.

4. A collapsible garment and equipment bag according to claim 1, wherein said center portion and said perforated end portions are of roughly the same size, shape, and material so as to allow limited overlap.

5. A collapsible garment and equipment bag according to claim 1, wherein said perforated end portions are composed of a material which allows air to pass therethrough.

6. A collapsible garment and equipment bag according to claim 1, wherein said closure means begins on a distal edge of said center portion perpendicular to the axis of fold and opposite the distal edge of center portion perpendicular to the axis of fold.

7. A collapsible garment and equipment bag according to claim 1, wherein said carrying means is adjustable.

8. The collapsible garment and equipment bag according to claim 1, wherein the center portion is wider in dimension.

9. The collapsible garment and equipment bag according to claim 8, wherein said center portion contains one or more pockets for retaining items, the pockets being dimensioned and arranged to facilitate storage, balancing and sorting of items.

10. The collapsible garment and equipment bag according to claim 1, wherein the center portion and perforated end portions contain a plurality of securement loops.

11. The collapsible garment and equipment bag according to claim 1, wherein three of the four edges of the center portion are closed so as to form a pocket.

12. The collapsible garment and equipment bag according to claim 11, wherein said pocket contains a closure means.

13. The collapsible garment and equipment bag according to claim 11, wherein at least one carrying means is attached at a distal corner of the transverse edge of the impermeable center portion along the axis of fold and a distal corner of the perforated end portions.

14. A method for loading a collapsible garment and equipment bag after completion of a sporting event by a user in which the user has equipment with degrees of soiling, comprising:
(a) making the collapsible garment and equipment bag so that it comprises an impermeable surface and a permeable containment portion together into a relatively planar configuration;
(b) placing the bag upon a bag placement surface;
(c) standing on said impermeable surface of said bag;
(d) disrobing and placing at least some of the soiled equipment on the impermeable surface of the bag leaving remaining equipment unplaced in the bag;
(e) stepping off the impermeable surface of the bag and onto the bag placement surface;
(f) placing at least some of the remaining equipment in the permeable portion of the bag; and
(e) closing the bag for containment.

15. The method of claim 14, wherein the sporting event is paint ball.

16. The method of claim 14, wherein the at least some of the soiled equipment is comprised of shoes, cleats, helmet, mask, gloves, pads and the like.

17. The method of claim 14, wherein the remaining equipment is comprised of jerseys, socks, undergarments, tee shirts, apparel, and the like.
